(19) United States
(12) Patent Application Publication
(10) Pub. No.: US 2004/0014450 A1
(43) Pub. Date: Jan. 22, 2004

(54) Signal receiving apparatus and gain control method using analog control AGC and step control AGC

(76) Inventors: Akio Yamamoto, Hiratsuka (JP); Yutaka Igarashi, Yokohama (JP); Isao Ikuta, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/617,797

(22) Filed: Jul. 14, 2003

(30) Foreign Application Priority Data
Jul. 15, 2002 (JP) 2002-205835

(51) Int. Cl. H04B 1/18

(52) U.S. Cl. 455/307; 455/280

(57) ABSTRACT

A signal receiving apparatus comprises an analog control AGC having a continuously varying gain and a step control AGC having a gain switched in steps, one of which is used to control the gain of a baseband signal, and the other of which is used to control the gain of the gain controlled signal.

### BACKGROUND OF THE INVENTION

The present invention relates to a signal receiving apparatus such as a portable terminal for receiving digitally modulated high frequency signals, and a gain control method.

For portable telephones, the GSM (Global System for Mobile communications) scheme is dominantly used in Europe, while the WCDMA scheme (Wideband Code Division Multiple Access scheme which has a transmission band and a reception band allocated to 1,920-1,980 MHz and 2,110-2,170 MHz, respectively, in a 2-GHz band. Hereinafter called the “WCDMA2000”) has been inaugurated in Japan as the third generation standard. Receiver circuits in these portable telephones rely on a direct conversion method for directly converting a received RF signal to I/Q signals in a base band, as described in “A Single-Chip Quad-Band Direct-Conversion GSM/GPRS RF Transceiver with Integrated VCOs and Fractional-N Synthesizer,” ISSCC 2002, 14.2 (Document (1)), and U.S. Pat. No. 5,483,691 entitled “ZERO INTERMEDIATE FREQUENCY RECEIVER HAVING AN AUTOMATIC GAIN CONTROL CIRCUIT” (Document (2)). The direct conversion method advantageously eliminates an intermediate frequency filter because it does not use any intermediate frequency signal. Also, the direct conversion method employs a DC offset compensation circuit to cancel the effect of DC offset produced in the base band because the DC offset causes degraded performance. In addition, a baseband gain control circuit employs step AGC (Automatic Gain Control Circuit) which switches devices in response to a digital control signal to change the gain in steps, or analog AGC which continuously controls the gain in response to an analog control signal.

### SUMMARY OF THE INVENTION

With the step AGC based on the device switching, transient response disturbance can occur. Since the GSM scheme is one type of TDD (Time Division Duplex which performs transmission and reception at the same frequency in time-division) in which transmission and reception are multiplexed in time, a receiving operation is intermittently performed during a call or a data communication, so that the gain of the step AGC can be set during a period in which no receiving operation is performed. For this reason, the foregoing transient response disturbance does not incur any problem.

On the other hand, since the WCDMA scheme is one type of FDD (Frequency Division Duplex which performs transmission and reception at different frequencies) in which transmission and reception are multiplexed in frequency, a receiving state exists at all times during a call or a data communication. Therefore, with the employment of the step AGC based on the device switching, the designing should account for the effect of transient response disturbance, as described in the above cited Document (2). For example, one approach for avoiding the effect of the transient response disturbance involves ensuring a sufficient time interval for the AGC control. However, in consideration of mobile reception with a varying reception level, the control interval must be reduced, in which case a mobile terminal would be affected by the transient response disturbance.

On the other hand, some gain control system employs a transconductance amplifier. This is an analog AGC mode which changes a current value to vary the conductance for continuously varying the gain over a control voltage. Though this system is free from the transient response disturbance because the gain is continuously varied, its circuit is slightly complicated as compared with the step AGC and in some cases requires larger current consumption. In addition, for covering a wide dynamic range, the AGC must be configured in multiple steps, possibly causing an increase in power consumption.

It therefore is an object of the present invention to provide a signal receiving apparatus and a gain control method which solve the problems in the prior art.

It is another object of the present invention to provide a signal receiving apparatus and a gain control method which perform an automatic gain control in a base band, as is done in a direct conversion receiver, to permit a reduction in power consumption without suffering from the effect of transient response disturbance.

To achieve the above objects, the present invention provides a signal receiving apparatus for converting a received high frequency signal down to a baseband signal for processing. The apparatus includes an analog control AGC having a continuously varying gain, and a step control AGC having a gain switched in steps, wherein a baseband signal is processed by the analog control AGC and step control AGC.

According to one aspect of the present invention, a signal receiving apparatus for converting a received high frequency signal down to a baseband signal for processing, including an analog control AGC having a continuously varying gain, and a step control AGC connected to the analog control AGC, and having a gain switched in steps, wherein one of the analog control AGC and the step control AGC controls the gain of the baseband signal, and the other of the analog control AGC and the step control AGC controls the gain of the gain controlled baseband signal.

In one embodiment of the present invention, the signal receiving apparatus further includes a memory for storing an offset signal in accordance with a gain changeable width upon switching the gain of the step control AGC, and a controller for reading the offset signal from the memory to control a signal for controlling the gain of the analog control AGC in accordance with the offset signal substantially at the same timing as or at a timing earlier than a timing at which the gain of the step control AGC is switched.

In another embodiment of the present invention, the signal receiving apparatus further includes an amplifier having a gain switched in steps for amplifying the received high frequency signal, and a frequency converter for converting the high frequency signal from the amplifier down to the baseband signal, wherein the gain of the step control AGC is switched at a first reception level, and the gain of the amplifier is switched at a second reception level higher than the first reception level.

In another embodiment of the present invention, the gain of the step control AGC is switched at a first reception level when the reception level is increasing, and at a second reception level different from the first reception level when the reception level is decreasing. The gain of the amplifier is switched at a third reception level when the reception level is increasing, and at a fourth reception level different from the third reception level when the reception level is decreasing. The first reception level and the second reception level are lower than the third reception level and the fourth reception level, respectively.

As described above, since a combination of step control AGC and analog control AGC is used for the AGC mode for use in the base band in a direct conversion receiver and the like, the present invention can effectively reduce the number of analog control AGCs and the current consumption. Also, when the analog control AGC is used to finely control the gain, the step control AGC can control the gain at wider time intervals, thereby avoiding the effect of transient response disturbance. Further, when the gain is changed by the step control AGC, the gain can be controlled in association with the analog control AGC such that the gain does not suddenly fluctuates.

Also, upon switching the gain of the step control AGC, an analog gain control signal applied to the analog control AGC is changed by an offset signal to avoid an excessively large change in the gain of a received signal which would otherwise by caused by switching the gain of the step control AGC.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating a first embodiment of a signal receiving apparatus and a gain control system according to the present invention;

FIG. 2 is a block diagram illustrating a second embodiment of the signal receiving apparatus and gain control system according to the present invention;

FIG. 3 is a characteristic graph showing a specific example of the control voltage versus gain characteristic of analog control AGC in FIGS. 1 and 2;

FIG. 4 is a characteristic graph showing a specific example of the control bit versus gain characteristic of the step control AGC in FIGS. 1 and 2;

FIG. 5 is a schematic circuit diagram illustrating a specific example of the analog control AGC in FIGS. 1 and 2;

FIG. 6 is a schematic circuit diagram illustrating a specific example of the STEP control AGC in FIGS. 1 and 2;

FIG. 7 is a characteristic graph showing a specific example of the gain control characteristic for a reception level in the first and second embodiments illustrated in FIGS. 1 and 2;

FIG. 8 is a flow chart for describing a control operation performed by a controller for implementing the operation shown in FIG. 7;

FIG. 9 is a characteristic graph showing another specific example of the gain control characteristic for the reception level in the first and second embodiments illustrated in FIGS. 1 and 2;

FIG. 10 is a flow chart for describing a control operation performed by the controller for implementing the operation shown in FIG. 9;

FIG. 11 is a block diagram illustrating a third embodiment of the signal receiving apparatus and gain control system according to the present invention;

FIG. 12 is a flow chart for describing a control operation performed by the controller in the third and fourth embodiments;

FIG. 13 is a block diagram illustrating a fourth embodiment of the signal receiving apparatus and gain control system according to the present invention;

FIGS. 14A, 14B are waveform charts illustrating a change in gain in a reception processing unit caused by switching the gain of the step control AGC in comparison of the embodiments illustrated in FIGS. 11 and 13 with the embodiments illustrated in FIGS. 1 and 2; and

FIG. 15 is a block diagram illustrating a specific example of a WCDMA communication terminal which employs the signal receiving apparatus and gain control system according to the present invention.

### DETAILED DESCRIPTION OF THE EMBODIMENTS

In the following, a signal receiving apparatus and a gain control system according to the present invention will be described in connection with several embodiments thereof with reference to the accompanying drawings. In the respective drawings, parts having the same functions are designated the same reference numerals, and repeated description thereon will be omitted.

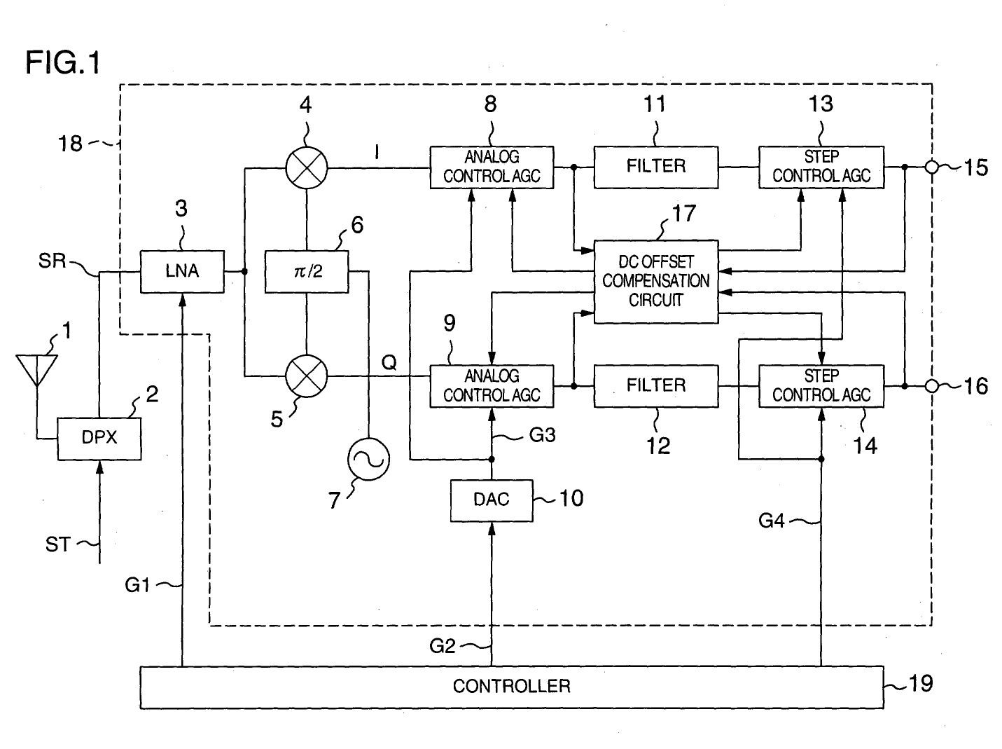

FIG. 1 is a block diagram illustrating a first embodiment of a signal receiving apparatus and a gain control system according to the present invention, which comprise an antenna 1; a diplexer (DPX) 2; a low noise amplifier (LNA) 3; mixers 4, 5; a 90° phase shifter 6; a VCO (voltage controlled oscillator) 7; analog control AGCs (automatic gain control amplifiers) 8, 9; a D/A (digital-to-analog) converter 10; filters 11, 12; step control AGCs 13, 14; output terminals 15, 16 for delivering I (In-phase) and Q (Quadrature-phase) signals; a DC offset compensation circuit 17; a reception processing unit 18; and a controller 19.

In FIG. 1, the first embodiment, which is configured to receive a digitally modulated signal, comprises the transmission/reception antenna 1, diplexer 2, reception processing unit 18 and controller 19, while the reception processing unit 18 comprises the low noise amplifier 3, mixers 4, 5, 90° phase shifter 6, VCO 7, analog control AGCs 8, 9, D/A converter 10, filters 11, 12, step control AGCs 13, 14, I/Q signal output terminals 15, 16, and DC offset compensation circuit 17. The controller 19, which comprises, for example, a CPU, a memory and the like, controls the switching of the gain of the low noise amplifier 3 through a digital gain switching control signal G1, and controls the switching of the gains of the step control AGCs 13, 14 through a digital gain switching control signal G4. A digital gain control signal G2 outputted from the controller 19 is converted to an analog gain control signal G3 by the D/A converter 10, such that the analog gain control signal G3 is used to control the gain of each analog control AGC 8, 9.

It should be noted that the first embodiment is designed to act as a transceiver which comprises the diplexer 2, a transmission system, not shown, and a reception system which constitutes the signal receiving apparatus. Alternatively, however, this embodiment may be a signal receiving apparatus which only includes the reception system (and therefore eliminates the diplexer 2). The same is applied to other embodiments, later described.

The following description will be focussed on the operation in the first embodiment.

A radio frequency signal (hereinafter called the “RF signal”) SR received by the antenna 1 is divided from an outgoing signal ST by the diplexer 2, and supplied to the reception processing unit 18. In the reception processing unit 18, the incoming received RF signal is amplified by the low noise amplifier 3, before it is supplied to the mixers 4, 5, respectively. An oscillation signal from the VCO 7 is supplied to the 90° phase shifter 6 which generates two oscillation signals which are out of phase from each other by p/2. The mixer 4 detects the RF signal using one of the oscillation signals, while the mixer 5 detects the RF signal using the other oscillation signal to convert the RF signal to orthogonally detected I, Q signals in the base band. The foregoing components constitute a radio frequency section which is responsible for directly converting the received RF signal to a baseband signal. In this way, the first embodiment constitutes a direct-conversion receiving apparatus. These I, Q signals are controlled in terms of the gain by the analog control AGCs 8, 9, respectively, which form part of a baseband section. After unwanted waves are removed by the filters 11, 12, the gains of the I, Q signals are controlled by the step control AGCs 13, 14, respectively, and outputted from the output terminals 15, 16, respectively.

The DC offset compensation circuit 17 detects DC offsets which are produced by the direct conversion from the outputs of the analog control AGCs 8, 9, and controls the DC biases of the analog control AGCs 8, 9 such that the detected DC offsets are reduced to zero. The DC offset compensation circuit 17 also detects DC offsets produced by the direct conversion from the outputs of the step control AGCs 13, 14, and controls the DC biases of the step control AGCs 13, 14 such that the detected DC offsets are reduced to zero.

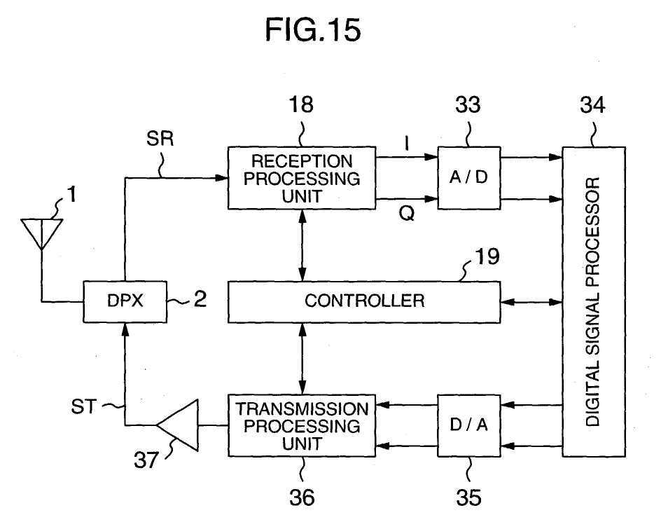

In a specific example in which the signal receiving apparatus and gain control system of the present invention are applied to a WCDMA communication terminal illustrated in FIG. 15, the controller 19 detects the level of a received signal (reception level), for example, from a digital signal processing circuit 34 (FIG. 15) which processes I, Q signals outputted from the output terminals 15, 16. The controller 19 generates the digital gain switching control signal G1 to control the switching of the gain of the low noise amplifier 3, and similarly generates the digital gain switching control signal G4 to control the switching of the gain of each step control AGCs 13, 14. The controller 19 further generates the digital gain control signal G2 which is converted to the analog gain control signal G3 by the D/A converter 10 for continuously controlling the gain of each analog control AGC 8, 9 through the analog gain control signal G4.

A method of controlling the gain with respect to the reception level in the reception processing unit 18 generally involves controlling the gain using the analog control AGCs 8, 9, and controlling the switching of the gain of each step control AGC 13, 14 or the low noise amplifier 4 when a particular reception level is reached. Therefore, the step control AGCs 13, 14 perform the control operation at long time intervals, and therefore are hardly affected by the transient response disturbance. The first embodiment can also employ the step control AGC which is advantageous in a less number of stages and lower power consumption, and can consequently reduce the power consumption.

As described above, the first embodiment advantageously eliminates the transient response disturbance and reduces the power consumption by using the step control AGCs and analog control AGCs for controlling the gain of each I, Q signal in the base band.

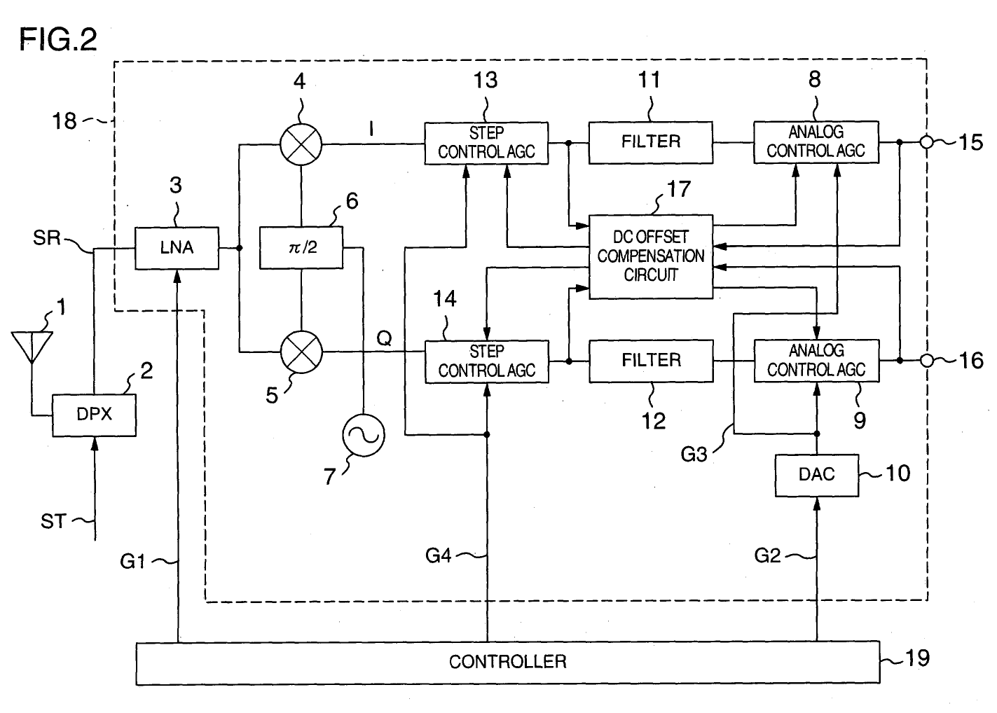

FIG. 2 is a block diagram illustrating a second embodiment of the signal receiving apparatus and gain control system according to the present invention, wherein parts corresponding to those in FIG. 1 are designated the same reference numerals and repeated description thereon will be omitted.

The second embodiment differs from the first embodiment illustrated in FIG. 1 in that the step control AGCs 13, 14 change places with the analog control AGCs 8, 9.

Specifically, as illustrated in FIG. 2, the step control AGCs 13, 14 are disposed on the input side of the filters 11, 12, while the analog control AGCs 8, 9 are disposed on the output side of the filters 11, 12, respectively. The control for and overall operation of these AGCs are similar to those in the first embodiment illustrated in FIG. 1. Consequently, the second embodiment provides similar advantages to the first embodiment.

In the second embodiment, the DC offset compensation circuit 17 detects DC offsets produced by the direct conversion from the outputs of the step control AGCs 8, 9 to control DC biases of the step control AGCs 8, 9 such that the detected DC offsets are reduced to zero. Also, the DC offset compensation circuit 17 detects DC offsets produced by the direct conversion from the outputs of the analog control AGCs 8, 9 to control DC biases of the analog control AGCs 8, 9 such that the detected DC offsets are reduced to zero.

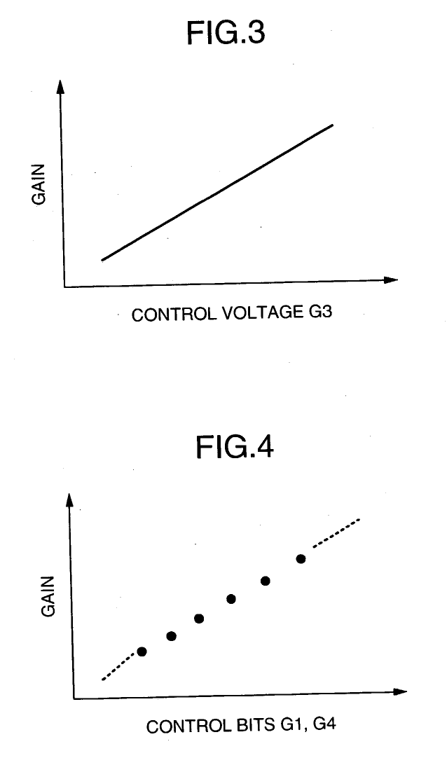

FIG. 3 shows a specific example of the gain characteristic to the analog gain control signal G3 in each of the analog control AGCs 8, 9 in FIGS. 1 and 2. As shown, the characteristic shows a continuously varying gain in response to the analog gain control signal G3 (control voltage).

FIG. 4 shows a specific example of the gain characteristic to the digital gain switching control signal G4 (control bit) of each of the step control AGCs 13, 14 in FIGS. 1 and 2, where the gain changes in response to each control bit to present a discontinuous step gain control characteristic. Since the step control AGC varies the gain in response to the control bit, it may be sometimes called “PGA” (Programmable Gain Amplifier). The low noise amplifier 3 also presents a similar gain characteristic to FIG. 4 in response to the digital gain switching control signal G1.

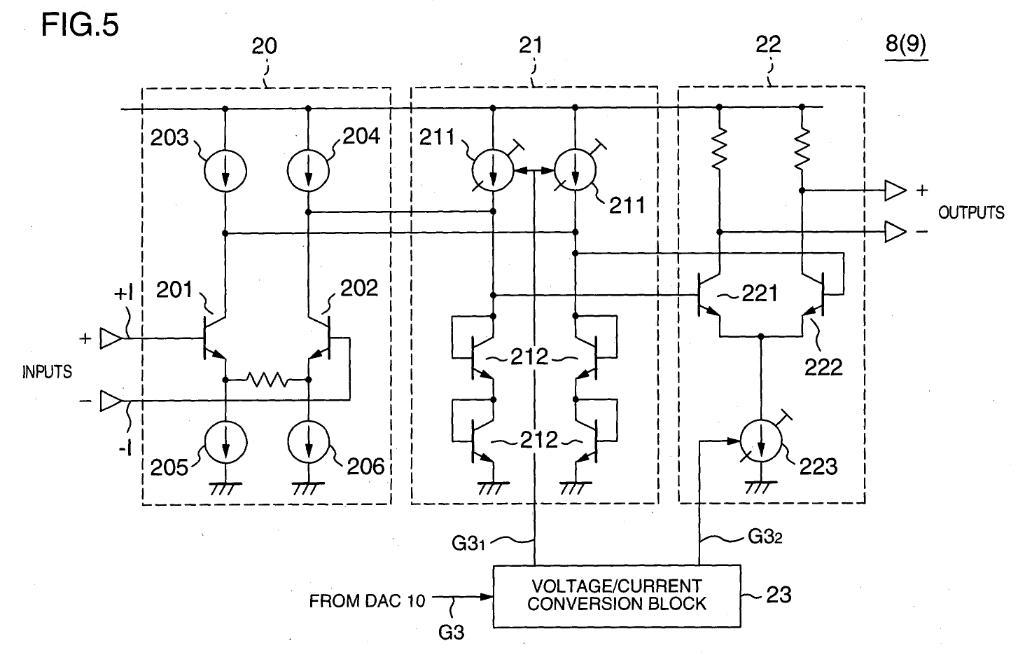

FIG. 5 is a schematic circuit diagram illustrating a specific example of each of the analog control AGCs 8, 9 in FIGS. 1 and 2, wherein the analog control AGC comprises differential pairs 20, 21, 22 and a voltage/current conversion block 23.

In FIG. 5, since the analog control AGCs 8, 9 are identical in circuit configuration and similar in operation, description will be made only on the analog control AGC 8. The analog control AGC 8 comprises a differential pair 20 composed of a pair of transistors 201, 202 and regulated current sources 203-206 connected to collectors and emitters of the transistors 201, 202, respectively; a differential pair 21 composed of a variable current source 211 and a regulated current source 212; and a differential pair 22 composed of a pair of transistors 221, 222 and a variable current source 223 connected in common to emitters of the transistors 221, 222. The differential pairs 20, 21, 22 are connected in series to make up a transconductance amplifier. The analog control AGC 8 is made up of such transconductance amplifiers connected in series in predetermined stages equal to or more than one. Here, the analog control AGC 8 is comprised of a single transconductance amplifier, wherein the differential pair 20 is supplied with an I signal (called the “+I signal) from the mixer 4, and a polarity inverted version of the same (called the “−I signal), which are amplified and outputted from the differential pair 22.

In the analog control AGC 8 of the configuration as described above, the analog gain control signal G3 outputted from the D/A converter 10 (FIGS. 1 and 2) as a control voltage is converted by the voltage/current conversion block 23 to generate control currents G3₁, G3₂. The control current G3₁ controls a variable current source 211 of the differential pair 21, while the control current G3₂ controls the variable current source 223 of the differential pair 22, thereby controlling the gain of the analog control AGC 8 as shown in FIG. 3. The same is applied to the analog control AGC 9 (FIGS. 1 and 2).

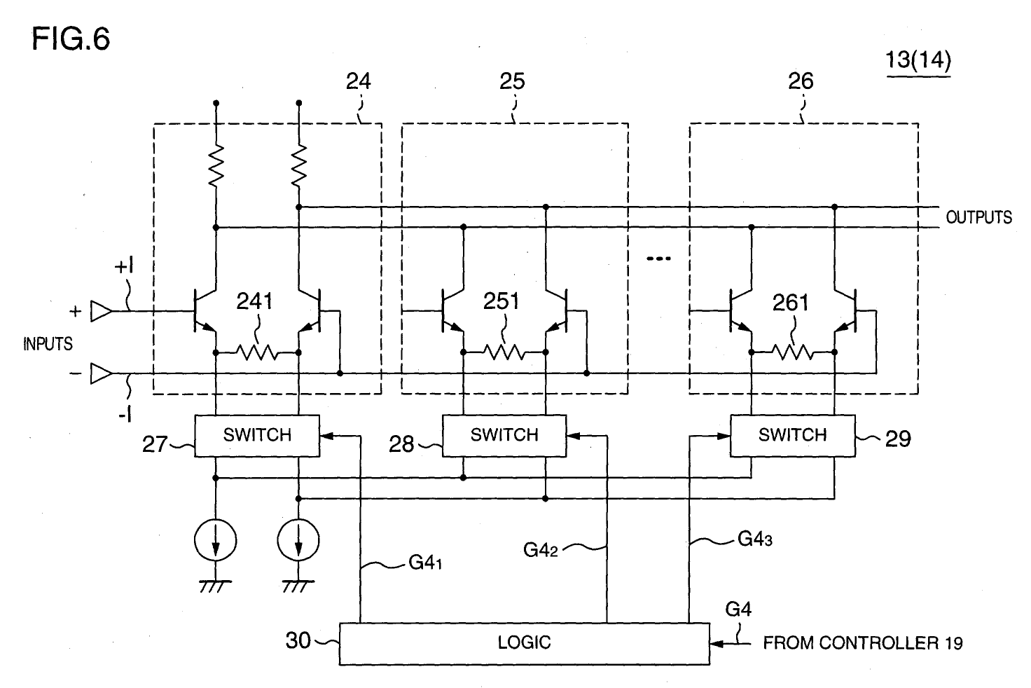

FIG. 6 is a schematic circuit diagram illustrating a specific example of each of the step control AGCs 13, 14 in FIGS. 1 and 2, where the step control AGC is composed of differential pairs 24, 25, 26, switches 27, 28, 29, a logic 30, and the like.

In FIG. 6, since the step control AGCs 13, 14 are identical in circuit configuration and similar in operation, description will be made only on the step control AGC 13. The step control AGC 13 comprises two or more differential pairs (while three differential pairs 24, 25, 26 are illustrated, two or four or more differential pairs may be employed instead) connected in parallel, which differs from one another in gain due to emitter resistances (241, 251, 261) different from one another. These differential pairs 24, 25, 26 are provided with associated switches 27, 28, 29 for turning on/off the differential pairs 24, 25, 26, respectively. These switches 27, 28, 29 control on/off the differential pairs 24, 25, 26 to select one of the differential pairs 24, 25, 26, so that the +I signal and −I signal are amplified by a selected differential pair and outputted therefrom.

The digital gain switching control signal (control bit) G4 outputted from the controller 19 (FIGS. 1 and 2) is supplied to the logic 30 to generate switch control signals G4₁, G4₂, G4₃ at “1” or “0” in accordance with this control bit G4. Here, only one of the switch control signals G4₁, G4₂, G4₃ is set at “1” while the remainders are all set at “0.” The switch control signal G4₁ controls the switch 27 associated with the differential pair 24 to turn on/off; the switch control signal G4₂ controls the switch 28 associated with the differential pair 25 to turn on/off; and the switch control signal G4₃ controls the switch 29 associated with the differential pair 26 to turn on/off. When the switch control signals G4₁, G4₂, G4₃ are “1,” the associated switches 27, 28, 29 turn on to make the respective differential pairs 24, 25, 26 operative, respectively. On the other hand, when the switch control signals G4₁, G4₂, G4₃ are “0,” the associated switches 27, 28, 29 turn off to make the respective differential pairs 24, 25, 26 inoperative, respectively. In this way, only one of the differential pairs 24, 25, 26 is selected for operation in accordance with the values of the associated digital gain switch control signals G4₁, G4₂, G4₃. Therefore, a change in the values of the digital gain switching control signals G4₁, G4₂, G4₃ results in a selection of an operative one from the differential pairs 24, 25, 26.

In this way, each of the step control AGCs 13, 14 has the gain switched in steps in accordance with the digital gain switching control signals G4, resulting in the gain characteristic shown in FIG. 4.

It should be noted that in the foregoing and subsequent embodiments, each of the step control AGCs 13, 14 can be switched only in two stages “H” and “L,” so that the step control AGC may be provided only with one of the differential pairs 24, 25, 26.

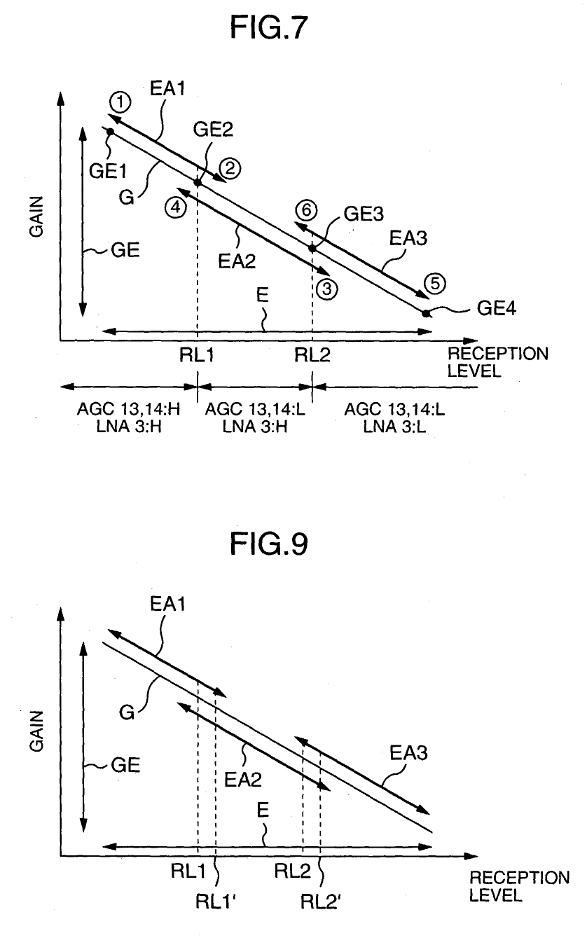

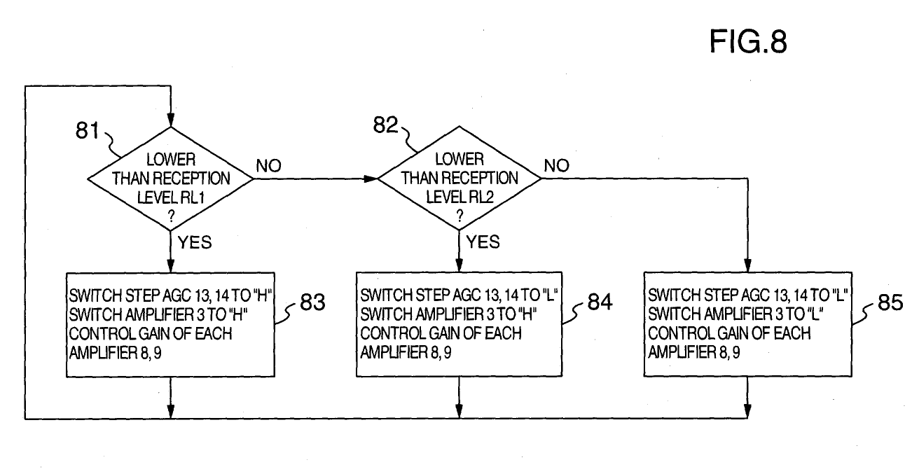

FIG. 7 is a characteristic graph showing a specific example of the gain control characteristic for a reception level in the first and second embodiments illustrated in FIGS. 1 and 2. In the following, the operation of the first and second embodiments will be described with reference to FIGS. 7, 8. FIG. 8 is a flow chart for describing the control operation performed by the controller 19 for the step AGCs 13, 14, analog control AGCs 8, 9 and amplifier 3 in order to implement the operation shown in FIG. 7.

In FIG. 7, the horizontal axis represents the reception level, while the vertical axis represents the gain of the reception processing unit 18. A characteristic curve G represents a required gain of the reception processing unit 18 for the reception level. In the first and second embodiments, assume that a gain control width GE is required for a reception level range E.

In this specific example, the gain can be switched in two stages to “H” (High) and “L” (Low) for each of the step control AGCs 13, 14, and likewise, the gain can be switched in two stages to “H” and “L” for the low noise amplifier 3 (FIGS. 1, 2). The gain of each step control AGC 13, 14 is switched at a reception level RL1, while the gain of the low noise amplifier 3 is switched at a reception level RL2. Of course, in the present invention, the gain can be switched in three or more stages for each of the step control AGCs 13, 14 and low noise amplifier 3.

Characteristic segments EA1, EA2, EA3 indicated by fat solid lines show gain controllable ranges for the analog control AGCs 8, 9, respectively. Here, in a reception level range below the reception level RL1, all the step control AGCs 13, 14 and low noise amplifier 3 have the gains at “H,” causing the analog control AGCs 8, 9 to continuously control the gain in the range indicated by the characteristic segment EA1 in accordance with a change in the reception level. In a reception level range equal to or higher than the reception level RL1 and lower than the reception level RL2, the step control AGCs 13, 14 have the gains at “L” (for example, a gain which is low in gain position or the like), and the low noise amplifier 3 has the gain at “H,” causing the analog control AGCs 8, 9 to continuously control the gain within the range indicated by the characteristic segment FA2 in accordance with a change in the reception level. In a reception level range equal to or higher than the reception level RL2, all the step control AGCs 13, 14 and low noise amplifier 3 have the gains at “L,” causing the analog control AGCs 8, 9 to continuously control the gain within the range indicated by the characteristic segment EA2 in accordance with a change in the reception level.

Here, the gain control operation shown in FIG. 7 will be described. Assuming now that the reception level is at the lowest level in the reception level range E, all the step control AGCs 13, 14 and low noise amplifier 3 have the gains at “H” so that the gains of the analog control AGCs 8, 9 exist at the higher end (1) of the characteristic segment EA1. This causes the reception control unit 18 to have a maximum gain GE1 (steps 81, 83).

Subsequently, as the reception level becomes higher, the gain of each analog control AGC 8, 9 becomes lower within the range of the characteristic segment EA1, causing the gain of the reception processing unit 18 to go down along the characteristic curve G. Then, as the gain of each analog control AGC 8, 9 reaches a reception level RL1 at the lower end (2) of the characteristic segment EA1 (step 81), the reception processing unit 18 has a gain GE2 on the characteristic curve G. However, at this time, the gain of each step control AGC 13, 14 switches from “H” to “L” in response to the digital gain control signal G4 from the controller 19 (step 84). Then, this switching of the gains causes the gain changeable range of the analog control AGCs 8, 9 to transition from the characteristic segment EA1 to the characteristic segment EA2, bringing the gain of each analog control AGC 8, 9 to the lower end (3) of the characteristic segment EA2. Consequently, the reception processing unit 18 has a gain GE3 on the characteristic segment GE3, but the gain of the analog control AGC 8, 9 increases, such that the reception processing unit 18 returns to the gain GE2, to reach the higher end (4) of the characteristic segment EA2. In this state, the gain of the reception processing unit 18 returns to the gain GE2.

As the reception level further increases to reach the reception level RL2 (step 82), the gain of the low noise amplifier 3 switches from “H” to “L” in response to the digital gain control signal G1 from the controller 19 (step 85). This causes the gain changeable range of the analog control AGCs 8, 9 to transition from the characteristic segment EA2 to the characteristic segment EA3. Thus, in the similar manner to the foregoing, this switching brings the gain of each analog control AGC 8, 9 to the lower end (5) of the characteristic EA3 to provide the reception control unit 18 with a gain GE4, but the gain of each analog control AGC 8, 9 increases to the higher end(6) of the characteristic segment EA3 such that the gain of the reception processing unit 18 reaches the gain GE3 at the reception level RL2.

In this way, when the reception level is increasing, the reception processing unit 18 experiences a temporary reduction in gain at the time the gains of the step control AGCs 13, 14 and low noise amplifier 3 switch from “H” to “L.” Subsequently, however, the reception processing unit 18 returns to have a predetermined gain as the gain of each analog control AGCs 8, 9 increases.

While the foregoing operation is performed as the reception level becomes higher, the operation reverse to the above is performed when the reception level becomes lower. For example, when the reception level changes from RL2 or higher to lower than RL2 (step 82), the gain of the low noise amplifier 3 switches from “L” to “H” in response to the digital gain control signal G1 from the controller 19 (step 84).

Further, as the reception level changes from RL1 or higher to lower than RL1 (step 81), the gain of each step control AGC 13, 14 switches from “L” to “H” in response to the digital gain control signal G4 from the controller 19 (step 83). Immediately before this switching, each analog control AGC 8, 9 has the gain at the higher end (4) of the characteristic segment EA2, while the reception processing unit 18 has the gain GE2. The switching causes a gain changeable range of the analog control AGCs 8, 9 to transition from the characteristic segment EA2 to the characteristic segment EA1, and their gains reach the higher end (1) of the characteristic segment EA1. Thus, the reception processing unit 18 has the gain GE1 which is higher than the predetermined gain GE2 at the reception level RL1, but the gain of each analog control AGC 8, 9 decreases to the lower end (2) of the characteristic segment EA1, causing the gain of the reception processing unit 18 to reach the predetermined gain GE2.

In this way, when the reception level is decreasing, the reception processing unit 18 experiences a temporary increase in gain at the time the gains of the step control AGCs 13, 14 and low noise amplifier 3 switch from “L” to “H.” Subsequently, however, the reception processing unit 18 returns to have a predetermined gain as the gain of each analog control AGC 8, 9 decreases.

As described above, in this specific example, as the reception level becomes higher, the gains of the step control AGCs 13, 14 for I, Q signals in the base band are first switched from “H” to “L.” As the reception level further becomes higher, the gain of the low noise amplifier 3 for a received signal in the RF band is switched from “H” to “L.” In this way, when the reception level is increasing, the gain of each step control AGC 13, 14 is switched from “H” to “L” while the low noise amplifier 3 is operated to suppress noise, i.e., before the gain of the low noise amplifier 3 is switched from “H” to “L.” On the other hand, when the reception level is decreasing, the gain of each step control AGC 13, 14 is switched from “L” to “H” while the low noise amplifier 3 is operated to suppress noise, i.e., after the gain of the low noise amplifier 3 is switched from “L” to “H.” With this strategy, the controller 18 can control the gain with reduced influence by the noise, suppressed noise index, and ensured distortion performance.

In a normal state with a high reception level, the analog control AGCs 8, 9 are used to control the gain, and as the reception level decreases to lower than the particular level RL2 or RL1, the step control AGCs 13, 14 or low noise amplifier 3 are operated after their gains are switched. Therefore, the step control AGCs 13, 14 control the switching of gain at longer time intervals (i.e., a time period from a switching of the gain to the next switching), and they operate as amplifiers with constant gains during this interval, so that they are substantially free from the effect of transient response disturbance.

In the foregoing example, when the reception level increases, the gain of each step control AGC 13, 14 is switched to “L” at the time the reception level reaches RL1, and the gain of the low noise amplifier 3 is switched to “L” at the time the reception level reaches RL2. Alternatively, the gain of the step control AGC 13, 14 may be switched to “L” at the time the reception level exceeds RL1, and the gain of the low noise amplifier 3 may be switched to “L” at the time the reception level exceeds RL2.

Likewise, in the foregoing example, when the reception level decreases, the gain of the low noise amplifier 3 is switched to “H” at the time the reception level falls below RL2, and the gain of each step control AGC 13, 14 is switched to “H” at the time the reception level falls below RL1. Alternatively, the gain of the low noise amplifier 3 may be switched to “H” at the time the reception level RL2 reaches RL2, and the gain of each step control AGC 13, 14 may be switched to “H” at the time the reception level reaches RL1. The same is applied to a third and a fourth embodiment, later described.

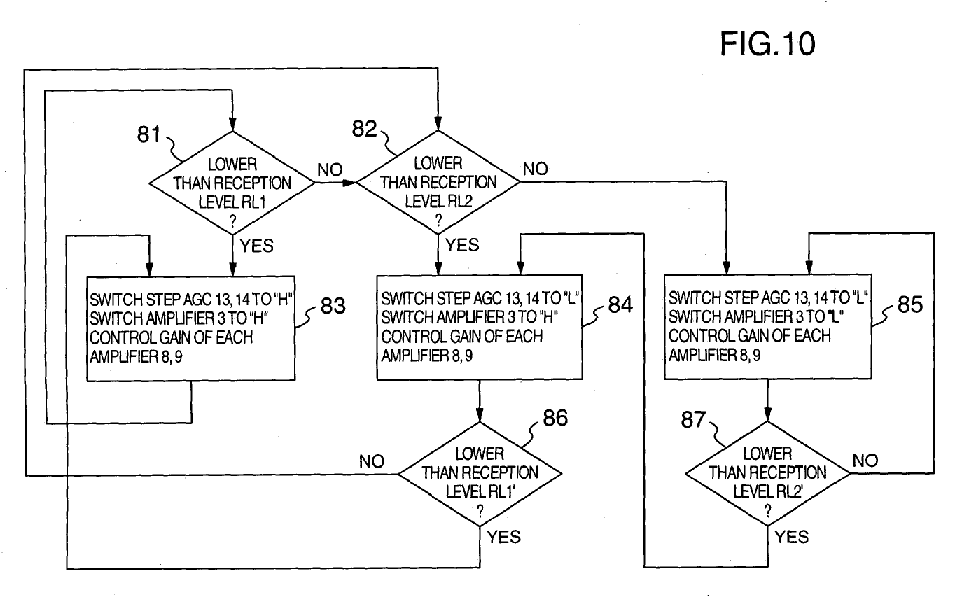

FIG. 9 is a graph showing another specific example of the gain control characteristic for the reception level in the first and second embodiments illustrated in FIGS. 1 and 2, where parts corresponding to those in FIG. 7 are designated the same reference numerals, and description thereon will be omitted. In the following, the operation of this example will be described with reference to FIGS. 9 and 10. FIG. 10 is a flow chart for describing a control operation performed by the controller 19 for the step control AGCs 13, 14, analog control AGCs 8, 9 and low noise amplifier 3 in order to implement the operation shown in FIG. 9.

This specific example differs from the specific example shown in FIG. 7 in that a reception level RL1′ is added for switching the gain of each step control AGC 13, 14, and a reception level RL2′ is added for switching the gain of the low noise amplifier 3. When the reception level changes from a low level to a high level, the gain is switched for the step control AGCs 13, 14 at the time the reception level reaches RL1, and for the low noise amplifier 3 at the time the reception level reaches RL2, respectively.

On the other hand, when the reception level changes from a high level to a low level, the gain is switched for the step control AGCs 13, 14 at the time the reception level reaches lower than the reception level RL1′ higher than RL1, and for the low noise amplifier 3 at the time the reception level reaches lower than the reception level RL2′ higher than RL2. More specifically, as the reception level changes, for example, from RL2′ or higher to lower than RL2′ (step 87), the gain of the low noise amplifier 3 switches from “L” to “H” in response to the digital gain control signal G1 from the controller 19 (step 84).

Further, as the reception level changes from RL1′ or higher to lower than RL1′ (step 86), the gain of each step control AGCs 13, 14 switches from “L” to “H” in response to the digital gain control signal G4 from the controller 19 (step 83).

In this way, the gain switching operation is provided with a hysteresis characteristic. Such hysteresis gain switching is also performed under control of the controller 19, as illustrated in the flow chart of FIG. 10.

The reception level RL1′ may be lower than the reception level RL1. Also, irrespective of whether the reception level RL1′ is higher or lower than the reception level RL1, the reception level RL2′ may be lower than the reception level RL2. In essence, the fourth embodiment provides the hysteresis for the gain switching by setting the reception levels RL1′, RL2′ different from the reception levels RL1, RL2 in addition to them. Therefore, the difference between the reception levels RL1′ and RL1, and the difference between the reception levels RL2′ and RL2 may be on the order of 5-10 dB when the reception level extends, for example, over 80 dB, but they are not limited to such values.

Without such hysteresis at the gain switching points as in the specific example shown in FIG. 7, if the reception level fluctuates up and down at short time intervals near the reception levels RL1, RL2 at which the gain should be switched, the gains of the step control AGCs 13, 14 and low noise amplifier 3 will switch between “H” and “L” at short time intervals, possibly causing the transient response disturbance. In contrast, in the specific example shown in FIG. 9 which provides the hysteresis at the gain switching points as mentioned above, even if the reception level fluctuates up and down near the reception levels at which the gain should be switched, the step control AGCs 13, 14 and low noise amplifier 3 are free from the continuous and repetitive changes in the gain between “L” and “H,” thereby successfully preventing the transient response disturbance.

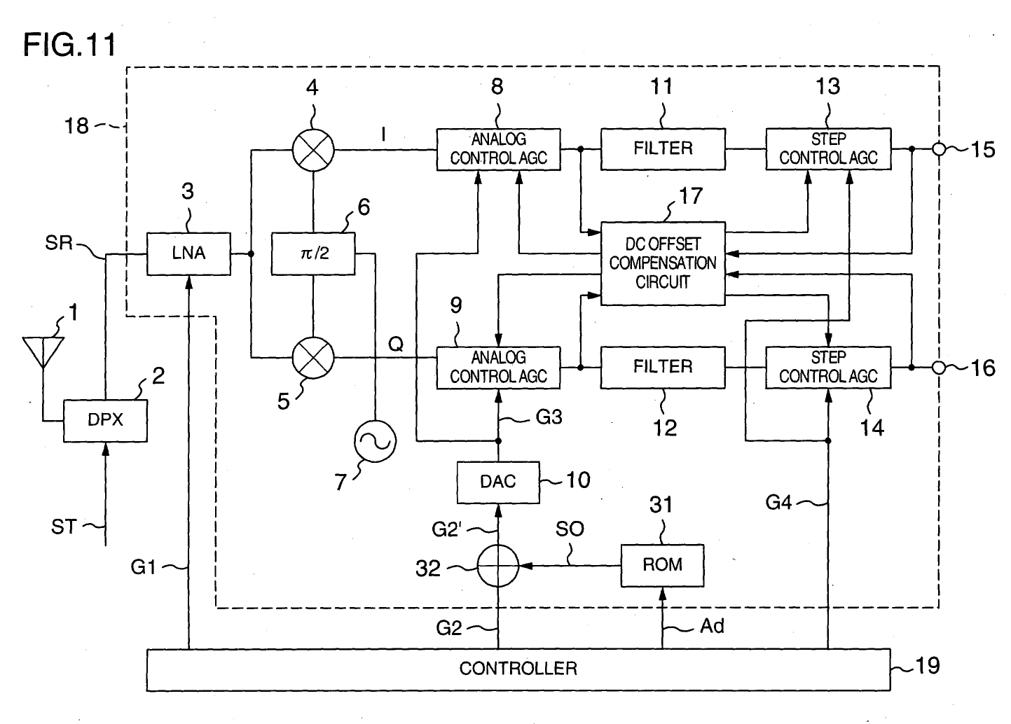

FIG. 11 is a block diagram illustrating a third embodiment of the signal receiving apparatus and gain control system according to the present invention, which additionally comprise a ROM (Read Only Memory) 31 and an adder 32. Parts corresponding to those in FIG. 1 are designated the same reference numerals, and repeated description thereon will be omitted.

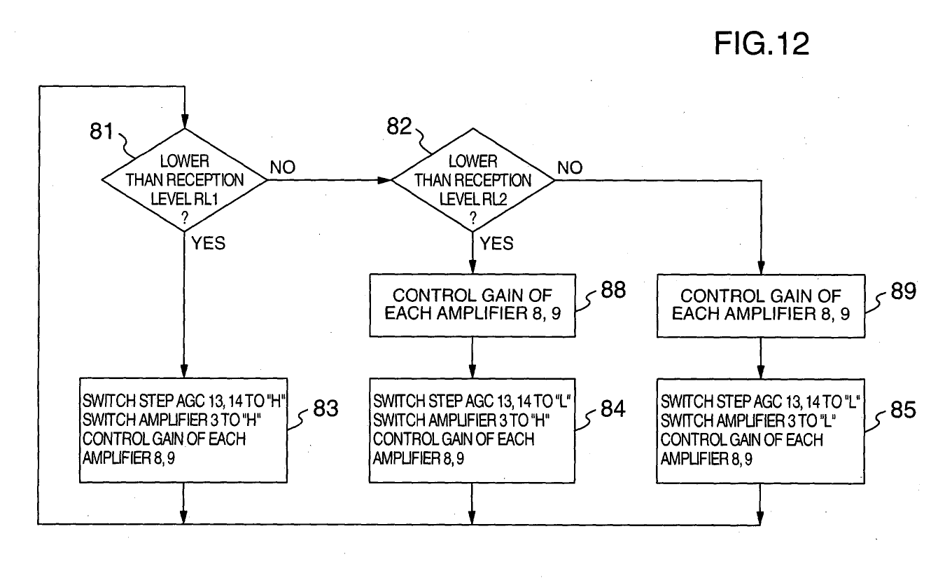

In the following, a control operation performed by the controller 19 in the third embodiment will be described with reference to a flow chart illustrated in FIG. 12. In FIG. 11, the adder 32 and ROM 31 are provided in the control system associated with the analog control AGCs 8, 9. The ROM 31 stores offset signals having different magnitudes from one another, each of which is assigned an address. The offset signals SO are set to those values which are in accordance with the magnitudes of changes in gain (gain changeable widths) in the step control AGCs 13, 14 caused by the switching of the gain of each step control AGC 13, 14 in response to the digital gain switching control signal G4. In other words, the values in accordance with the magnitudes of changes in gain may be any values smaller than the magnitudes of changes in the gain in the step control AGCs 13, 14 caused by the gain switching, and are preferably as close as possible to the magnitudes of changes in gain. The controller 19 outputs an address signal for specifying a particular offset signal SO to the ROM 31 for selectively reading and applying the offset signal SO to the adder 32 substantially simultaneously with the gain switching or before the gain switching. Specifically, when the reception level becomes higher to reach RL1 or becomes lower to reach RL1 (step 82), the controller 19 applies the ROM 31 with the address signal Ad for specifying a corresponding offset signal SO for reading this offset signal SO from the ROM 31. The specified offset signal OS is read from the ROM 31 from the address specified by the address signal AD, and is applied to the adder 32. The adder 32 adds the offset signal SO to the digital gain control signal G2 outputted from the controller 19 at this time, and supplies the D/A converter 10 with a resulting digital gain control signal G2′ which is the sum of the digital gain control signal G2 and the offset signal SO. The D/A converter 10 generates an analog control signal G3 which is applied to the analog control AGCs 8, 9 (step 88).

The offset signal SO is read from the ROM 31 and applied to the adder 32 at a timing substantially simultaneously with the gain switching or before the gain switching, and preferably earlier from the gain switching time by 2-3 slots or less, where one slot is 667 microseconds in the WCDMA scheme.

In the foregoing embodiment, a single offset signal SO may be read with suffice because the gain of each step control AGC 13, 14 is switched in two stages “H” and “L.” Therefore, when the gain of each step control AGC 13, 14 is switched in three or more stages, two or more different sets of offset signals SO may be stored such that one is selectively read from an associated set in accordance with particular gain switching of the step control AGCs 13, 14.

Likewise, for switching the gain of the low noise amplifier 3, an offset signal may be added to the digital gain control signal G1 in accordance with the magnitude of a change in gain of the low noise amplifier 3. Specifically, when the reception level becomes higher to reach RL2 or becomes lower to reach RL2 (step 83), the controller 19 may read a corresponding offset value SO′ from the ROM 31, adds the offset signal SO′ to the digital gain control signal G1, and applies the resulting control signal to the analog control AGCs 8, 9 (step 89).

In this way, when the gain of each step control AGC 13, 14 is switched in response to the digital gain switching control signal G4, the analog gain control signal G3 applied to the analog control AGCs 8, 9 is changed by the offset signal SO from the ROM 31, thereby preventing an excessive change in gain of the reception processing unit 18, possibly caused by the switching of the gain of each step control AGCs 13, 14, and preventing the reception processing unit 18 from saturating.

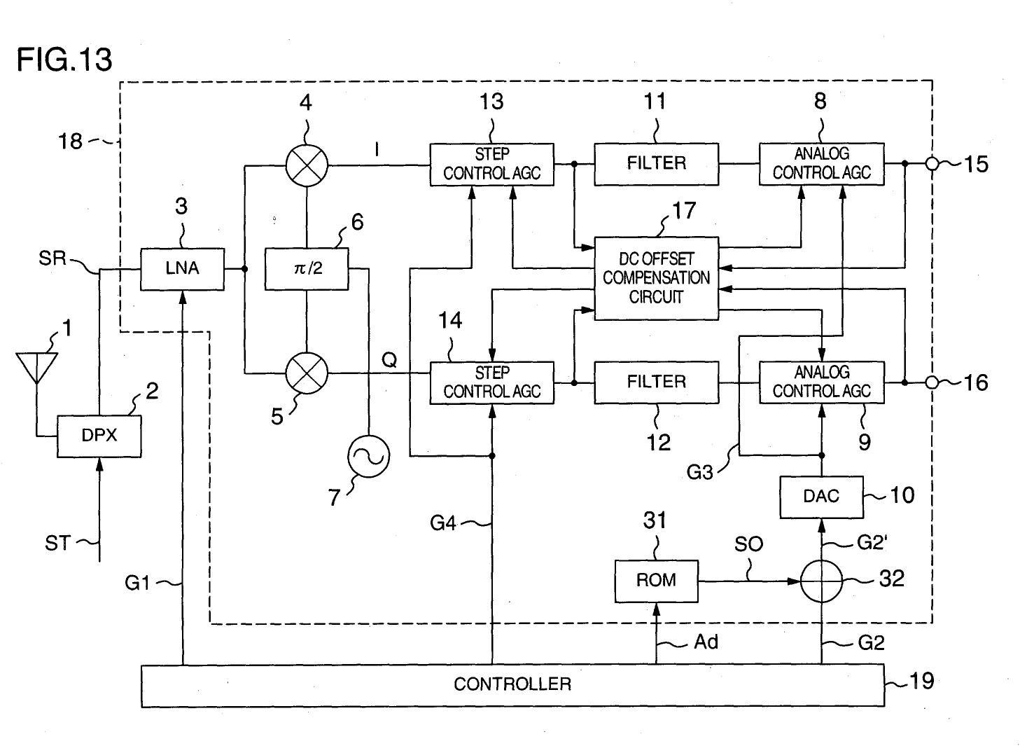

FIG. 13 is a block diagram illustrating a fourth embodiment of the signal receiving apparatus and gain control system according to the present invention, where parts corresponding to those in FIG. 11 are designated the same reference numerals, and repeated description thereon will be omitted.

The fourth embodiment differs from the third embodiment illustrated in FIG. 11 in that the step control AGCs 13, 14 change places with the analog control AGCs 8, 9.

Specifically, as illustrated in FIG. 13, the step control AGCs 13, 14 are disposed on the input side of the filters 11, 12, and the analog control AGCs 8, 9 are disposed on the output side of the filters 11, 12, together with their gain control system which comprises the D/A converter 10, ROM 31 and adder 32. The control for and overall operation of these AGCs are similar to those in the third embodiment illustrated in FIG. 11. Consequently, the fourth embodiment provides similar advantages to the third embodiment.

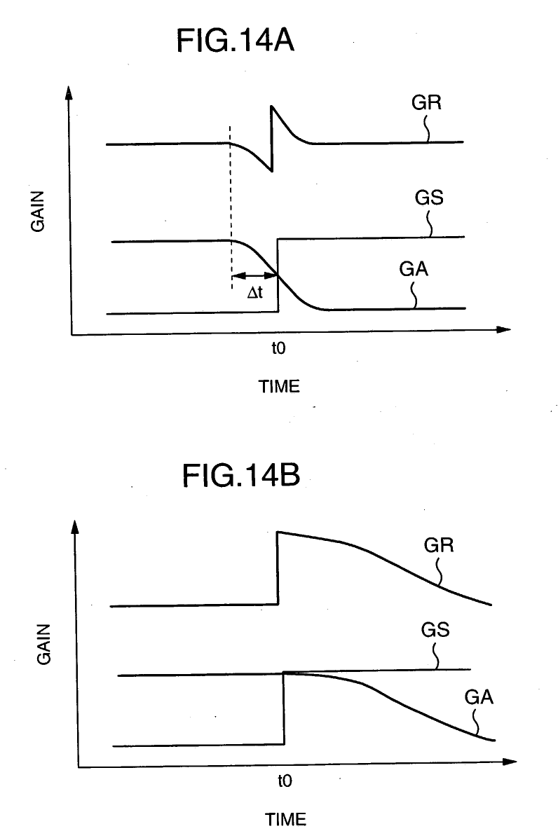

Next, description will be made on a change in the gain of the reception processing unit 18 caused by switching the gain of each step control AGCs 13, 14 in the third and fourth embodiments with reference to FIGS. 14A and 14B and further with reference to a flow chart for describing the control operation performed by the controller 19. Referring first to FIG. 14B, the description will begin with such a change in gain in connection with the aforementioned embodiments, for example, the first and second embodiments illustrated in FIGS. 1 and 2.

Assuming now that the gain GS of each step control AGC 13, 14 changes in steps in response to the digital gain switching control signal G4 at time t0, the gain GR of the reception processing unit 18 increases in steps at time t0 due to the gains of the low noise amplifier 3, analog control AGCs 8, 9 and step control AGCs 13, 14, as previously described in connection with FIG. 7. Subsequently, the gain GA of each analog control AGC 8, 9 slowly decreases in response to the analog gain control signal G3, and together with this, the gain GR of the reception processing unit 18 may slowly decrease and substantially converge to the original value. Therefore, a large change in the gain of each step control AGC 13, 14 could cause such problems as temporary saturation of the reception processing unit 18, though the gain GR of the reception processing unit 18 will eventually converge substantially to the original value.

On the other hand, in the third and fourth embodiments illustrated in FIGS. 13 and 14, the adder 32 adds an offset signal OS from the ROM 31 to the digital gain control signal G2 at a timing prior to the gain (GS) switching timing t0 in the step control AGCs 13, 14 by Dt (>0) to change the analog gain control signal G3 to decrease the gain GA of the analog gain AGC 8, 9, as can be seen in FIG. 14A. In this event, while the gain GA of each analog control AGC 8, 9 starts decreasing in the period Dt prior to time t0, the gain of the reception processing unit 18 can be prevented from increasing in excess because the gain GA changes from the value at time t0. Here, as each step control AGC 13, 14 has a larger gain GS, the analog gain control signal G3 is changed more largely by the offset signal SO read from the ROM 31 to more reduce the gain GA of the analog control AGC 8, 9. In this way, it is possible to prevent the gain GR of the reception processing unit 18 from increasing in excess at all times, making the reception processing unit 18 free from saturated signal characteristics.

The gain GA of the analog control AGC 8, 9 rapidly decreases due to the offset signal SO, and together with this, the gain GR of the reception processing unit 18 rapidly decreases after time t0. After the sudden decrease of the gain due to the offset signal SO, the gain GA of the analog gain AGC 8, 9 becomes lower until the gain GR of the reception processing unit 18 substantially converges to the original value from the state at that time. In this way, when the gain GR of each step control AGC 13, 14 switches in the increasing direction, the gain GA of each analog control AGC 8, 9 is rapidly decreased by the offset signal SO, thereby making it possible to suppress such an increase in the gain GR that would saturate the reception processing unit 18 and, moreover to reduce a time required for the gain GR of each step control AGC 13, 14 to converge from the increased value (at time t0) to the original value.

FIG. 15 is a block diagram illustrating a specific example of a WCDMA communication terminal which employs the signal receiving apparatus and gain control system according to the present invention. The communication terminal comprises an A/D (analog-to-digital) converter 33, a digital signal processor 34, a D/A converter 35, a transmission processing unit 36, and a PA (power amplifier) 37, where parts corresponding to those appearing in the previous figures are designated the same reference numerals, and repeated description thereon will be omitted.

In FIG. 15, a received signal (RF signal) SR from an antenna 1 is branched from an outgoing signal ST by a branching filter 2, and supplied to the reception processing unit 18 in any of the aforementioned first to fourth embodiments for the aforementioned reception processing. I, Q signals outputted from the reception processing unit 18 are converted to digital signals by the A/D converter 33 before they are supplied to the digital signal processor 34 for predetermined processing to generate data.

On the other hand, I, Q signals generated by processing data to be transmitted in the digital signal processor 34 are converted to analog I, Q signals by the D/A converter 35, and then processed by the transmission processing unit 36 for transmission to generate an outgoing signal ST. The outgoing signal ST is amplified by the PA 37 before it is transmitted from the antenna 1 through the branching filter 2.

In this way, the communication terminal in the foregoing specific example employs the signal receiving apparatus and gain control system in any of the aforementioned first to fourth embodiments for the reception processing unit 18, thus providing similar advantages to those of the embodiments.

The signal receiving apparatus and gain control system according to the present invention are not limited to the WCDMA scheme but can be applied to other communication terminals based on the GSM scheme and the like, and to wireless LAN as well.

As described above, since a combination of step control AGC and analog control AGC is employed for the AGC mode for use in the base band in a direct conversion receiver and the like, the present invention can reduce the number of analog control AGCs and the current consumption. Also, when the analog control AGC is used to finely control the gain, the step control AGC can control the gain at wider time intervals, thereby avoiding the effect of transient response disturbance. Further, when the gain is changed by the step control AGC, the gain can be controlled in association with the analog control AGC such that the gain does not suddenly fluctuates.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A signal receiving apparatus for converting a received high frequency signal down to a baseband signal for processing, said apparatus comprising:
an analog control AGC having a continuously varying gain; and
a step control AGC connected to said analog control AGC, said step control AGC having a gain switched in steps,
wherein one of said analog control AGC and said step control AGC controls the gain of said baseband signal, and the other of said analog control AGC and said step control AGC controls the gain of the gain controlled baseband signal.

2. A receiving apparatus according to claim 1, further comprising:
a memory for storing an offset signal in accordance with a gain changeable width upon switching the gain of said step control AGC; and
a controller for reading said offset signal from said memory to control a signal for controlling the gain of said analog control AGC in accordance with said offset signal substantially at the same timing as or at a timing earlier than a timing at which the gain of said step control AGC is switched.

3. A receiving apparatus according to claim 1 or 2, further comprising:
an amplifier for amplifying said received high frequency signal, said amplifier having a gain switched in steps; and
a frequency converter for converting the high frequency signal from said amplifier down to the baseband signal,
wherein the gain of said step control AGC is switched at a first reception level, and the gain of said amplifier is switched at a second reception level higher than the first reception level.

4. A receiving apparatus according to claim 1 or 2, further comprising:
an amplifier for amplifying said received high frequency signal, said amplifier having a gain switched in steps; and
a frequency converter for converting the high frequency signal from said amplifier down to the baseband signal,
wherein the gain of said step control AGC is switched at a first reception level when the reception level is increasing, and at a second reception level different from the first reception level when the reception level is decreasing;
the gain of said amplifier is switched at a third reception level when the reception level is increasing, and at a fourth reception level different from the third reception level when the reception level is decreasing; and
the first reception level and the second reception level are lower than the third reception level and the fourth reception level, respectively.

5. An incoming signal processing method for converting a received high frequency signal down to a baseband signal for processing, said method comprising one of the following steps of:
a) controlling the gain of the baseband signal in accordance with the level of the received signal, and continuously controlling the gain of the gain controlled signal in accordance with the level of the received signal; and
b) continuously controlling the gain of the baseband signal in accordance with the level of the received signal, and controlling the gain of the gain controlled signal in steps in accordance with the level of the received signal.

6. An incoming signal processing method for converting a received high frequency signal down to a baseband signal for processing, said method comprising the step of:
controlling the gain of the baseband signal using one of an analog control AGC having a continuously varying gain and a step control AGC having a gain switched in steps, and further controlling the gain of the gain controlled signal with the other of said analog control AGC and said step control AGC.

7. An incoming signal processing method according to claim 6, further comprising the step of:
controlling a signal for controlling the gain of said analog control AGC in accordance with an offset signal associated with a gain changeable width upon switching the gain of said step control AGC at the same timing as or at a timing earlier than a timing at which the gain of said step control AGC is switched.

8. An incoming signal processing method according to claim 6 or 7, further comprising the step of:
amplifying the received high frequency signal by an amplifier having a gain switched in steps, wherein:
the gain of said step control AGC is switched at a first reception level; and
the gain of said amplifier is switched at a second reception level higher than the first reception level.

9. An incoming signal processing method according to claim 6 or 7, further comprising the step of:
amplifying the received high frequency signal by an amplifier having a gain switched in steps,
wherein the gain of said step control AGC is switched at a first reception level when the reception level is increasing, and at a second reception level different from the first reception level when the reception level is decreasing;
the gain of said amplifier is switched at a third reception level when the reception level is increasing, and at a fourth reception level different from the third reception level when the reception level is decreasing; and
the first reception level and the second reception level are lower than the third reception level and the fourth reception level, respectively.
